(19) United States
(12) Patent Application Publication
(10) Pub. No.: US 2007/0099507 A1
(43) Pub. Date: May 3, 2007

(54) Electric connector

(76) Inventors: Koji Ohnishi, Tokyo (JP); Masahiko Matsue, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/559,729

(22) PCT Filed: Sep. 22, 2003
(86) PCT No.: PCT/JP03/12091

§ 371 Date: Dec. 7, 2005

(51) Int. Cl. H01R 13/648

(52) U.S. Cl. 439/608

(57) ABSTRACT

An electric connector for differential transmission principally transmitting a high-frequency electric signal where a ratio between the interval (a) between both signal terminals constituting a pair terminal being buried in a female contact housing and the interval (b) between the pair terminals is set a<b. Since the both signal terminals are molded integrally while being buried separately in modular housings obtained by dividing the female contact housing along a vertical direction to match ½ of the interval (a) between both signal terminals, the interval (a) of both signal terminals can be kept small and in parallel. Consequently, crosstalk can be improved furthermore.

### TECHNICAL FIELD

The present invention relates to an electric connector used for connection between a printed circuit board and a device or between printed circuit boards to each other in a computer, a server, or wiring between a backboard and a package, each connector being mainly for differential transmission for transmitting a high-frequency electric signal.

### BACKGROUND ART

Conventionally, as an electric connector 11 for a high-speed transmission channel, as shown in FIG. 9, a connector has been known, which comprises a housing for female contacts 14 in which female-type contacts 12a, 12b are molded by insert molding, a joint housing 15 for holding connection parts of the contacts 12a, 12b in reception holes by press fitting, and a backboard connector 17 having male-type contacts 16 to be jointed with the female-type contacts.

As a noise-control measure of the electric connector 11, a connector employing a differential transmission method is known, in which a signal is formed from a pair of terminals 12, and a high-speed signal is transmitted by the terminal pair. The terminal pair 12 is designed in a way that even if crosstalk or leakage of signal energy to adjacent terminals occurs, it is removed as a common mode noise. As shown in FIG. 10, ground terminals 13 are provided among respective terminal pairs 12 to prevent crosstalk to adjacent terminal pairs; thereby leakage of energy from one signal to another signal is prevented.

It is known that a distance “a” between the terminals of the pair is decreased compared with a distance “b” between the adjacent terminal pairs in order to reduce a crosstalk level of electric signals between respective terminal pairs 12. For example, it is known from JP-A-11-185886 and JP-A-2003-515896.

However, the electric connector 11 is intended to solve the problem by providing the ground terminals to reduce the crosstalk. This causes a problem of increase in number of components and complexity of the overall structure, resulting in increase in assembly cost. Furthermore, it causes a problem that the interval between the terminal pair 12 and the ground terminal 13 arranged between the terminal pairs is decreased due to progress of high-density package, thereby signal energy that is lost due to the ground terminal is increased, and consequently insertion loss is increased.

Moreover, there is a problem that since the interval (b) between the terminal pairs 12 is also decreased, terminal retaining force to be held as a press-in terminal is hardly secured, consequently terminals tend to bend, or bucking of the terminals occurs during press-fitting of the terminal.

Furthermore, there are various problems including a problem that since the contacts 12a, 12b of the terminal pair 12 are arranged in a vertical direction, length of lines to a circuit on a printed circuit board is different from each other, thereby propagation delay occurs in an electric signal, causing noise due to the relevant electric signal.

Thus, as shown in FIG. 11 to FIG. 12, it is proposed that the terminal pair 12 for transmitting an electric signal are lined up in a horizontal direction so that each of the lines to the circuit on the printed circuit board has the same length, thereby the problem of the propagation delay is dissolved and noise is prevented, in addition, the distance “b” between the terminal pairs 12 is set long by a zigzag layout to reduce the crosstalk.

However, in this case, as shown in FIG. 12, the female-type contacts 12a, 12b configuring the terminal pair 12 are integrally molded in one of divided housings for female-type contacts (hereinafter, referred to as module housing) 14a, 14b, . . . by insert molding, and the interval between the contacts is much reduced due to the progress of high-density package, therefore the terminal pair 12 of the relevant female-type contacts are hard to be fixed in a mold with the reduced interval.

Moreover, there is a problem that since thickness of the female-type contacts 12a, 12b is decreased in order to reduce the interval (a), the contacts are affected by injection pressure of melted resin during molding and thus transformed, therefore the interval (a) between the relevant female-type contacts does not become constant, consequently transmission characteristics are deteriorated.

Furthermore, there is a problem that when the interval between the female-type contacts 12a, 12b of a terminal pair 12 is further decreased, the relevant female-type contacts are sometimes touched to each other due to the injection pressure.

As another integral molding method of the module housing, the contacts can be molded in a method similar to double molding by inserting a thin insulating material between the terminals of the pair, however, in this case, the female-type contacts is hardly aligned with the thin insulating material, and workability is deteriorated because of the small thickness of the insulating material.

Thus, the electric connector according to the invention, which is proposed to dissolve such problems, aims to decrease the interval between the terminals of the pair and keep accuracy of parallelism of the terminals, and easily set the female-type contacts in a mold.

### DISCLOSURE OF INVENTION

The electric connector according to the invention has a plurality of signal terminals, a housing for female-type contacts in which the signal terminals are buried and integrally molded in a synthetic-resin housing with one ends of them being exposed, and a joint housing formed in a way that reception holes for receiving every one terminal pair, in which terminals are set close to each other in a horizontal direction in order to transmit an electric signal through the signal terminals, are lined up in the horizontal direction and set in several stages in a vertical direction, in which a relation of an interval (a) between the two signal terminals of the terminal pair to an interval (b) between the terminal pairs is a<b; wherein the two signal terminals of the terminal pair are separately buried and integrally molded in a module housing which is formed by dividing the housing for female-type contacts along the vertical direction in alignment with the midpoint of the interval (a) in the terminal pair.

The electric connector includes a feature that the reception holes are arranged in a zigzag layout in vertical, two stages.

According to the electric connector of the invention, adjacent two module housings are combined, thereby a terminal pair for transmitting an electrical signal is configured. Accordingly, the interval between the signal terminals of the terminal pair can be set to be extremely small. Moreover, the interval between the terminal pairs can be held parallel. In that case, any spacer is not necessary.

As further advantage, when a contact at one side of the terminal pair is set into a mold, since the contact can be molded in a manner that halfway points of the relevant contact are supported and fixed from both sides, setting operation into the mold is facilitated, and transformation and bending of the contact can be prevented.

### BRIEF DESCRIPTION OF DRAWINGS

FIG. 1 is a perspective view showing an electric connector according to the invention;

FIG. 2 is a perspective view showing a module housing in the electric connector according to the invention;

FIG. 3 is a similar perspective view showing a module housing in which female-type contacts are set in a zigzag layout symmetrically with respect to the module housing shown in FIG. 2;

FIG. 4 is a cross section view along a line A-A in Fig.3;

FIG. 5 is an explanatory view showing formation of terminal pairs of the female-type contacts in a condition that adjacent module housings are aligned with each other;

FIG. 6 is a cross section view along a line B-B in FIG. 5;

FIG. 7 is a schematic, explanatory view showing an arranged condition of terminal pairs of the female-type contacts and an effect of an electric field;

FIG. 8A is an explanatory view in the case that through-holes in a circuit of a printed circuit board in correspondence with a layout of the female-type contacts are arrayed in a zigzag layout;

FIG. 8B is an explanatory view in the case that the through-holes in the circuit of the printed circuit board in correspondence with the layout of the female-type contacts are arrayed in a lattice layout;

FIG. 9 is a cross section view of an electric connector according to a conventional example;

FIG. 10 is an explanatory view showing an arranged condition of terminal pairs of an electric connector 11 and an effect of an electric field in the conventional example;

FIG. 11 is an exploded perspective view showing the electric connector according to the conventional example; and

FIG. 12 is a cross section view showing a housing for female-type contacts.

### BEST MODE FOR CARRYING OUT THE INVENTION

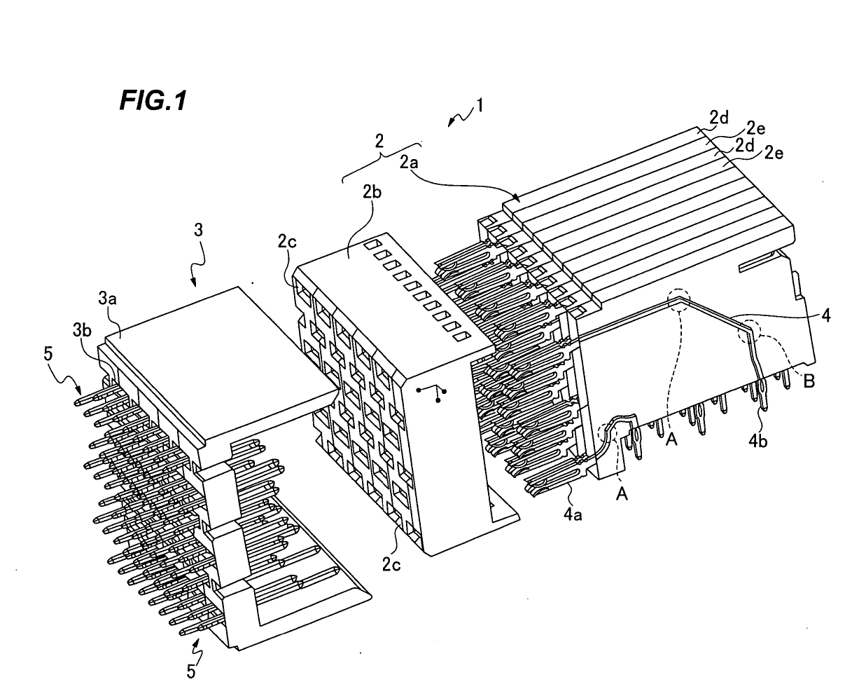

First, best mode for carrying out the invention is described with reference to FIG. 1 to FIG. 8B. As shown in FIG. 1, an electric connector 1 according to the invention comprises a female-type package connector 2 that is set on a printed circuit board and has one ends of contacts to be connected to a circuit and the other ends of contacts formed as female-type connection parts, and a backboard connector 3 that is provided in a chassis of a device with having male-type contacts for connection with the package connector 2.

The package connector 2 comprises a joint housing 2b in which reception holes 2c for receiving the male-type connection parts are arranged, a housing 2a for female-type contacts, and female-type contacts 4 that are molded in the housing 2a for female-type contacts by insertion molding.

A joint part 4a that is a female-type joint part of the female-type contact 4 is received in the reception hole 2c as a terminal pair for transmitting an electrical signal. Then, the relevant reception holes 2c are arranged in a zigzag layout where the holes are shifted half the pitch among the reception holes 2c in a horizontal direction for each of vertical, six stages without changing an interval in a vertical direction.

The female-type contacts 4 are provided, for example, in six stages in the vertical direction, and female-type contacts 4, 4 having an interval (a), which are set parallel and close to each other (for example, about 0.4 mm to 0.5 mm) in a horizontal direction, are arranged in the reception hole 2c as the terminal pair for an electric signal. Thickness of the female-type contact 4 is, for example, about 0.4 mm.

It is preferable for reducing the crosstalk that the proximate condition of the female-type contacts 4, 4 as the terminal pair is kept parallel from the joint part 4a to be jointed with a male-type contact 5 that is the opposite pair contact to a portion directly before a terminal part 4b to be pressed-in in the printed circuit board.

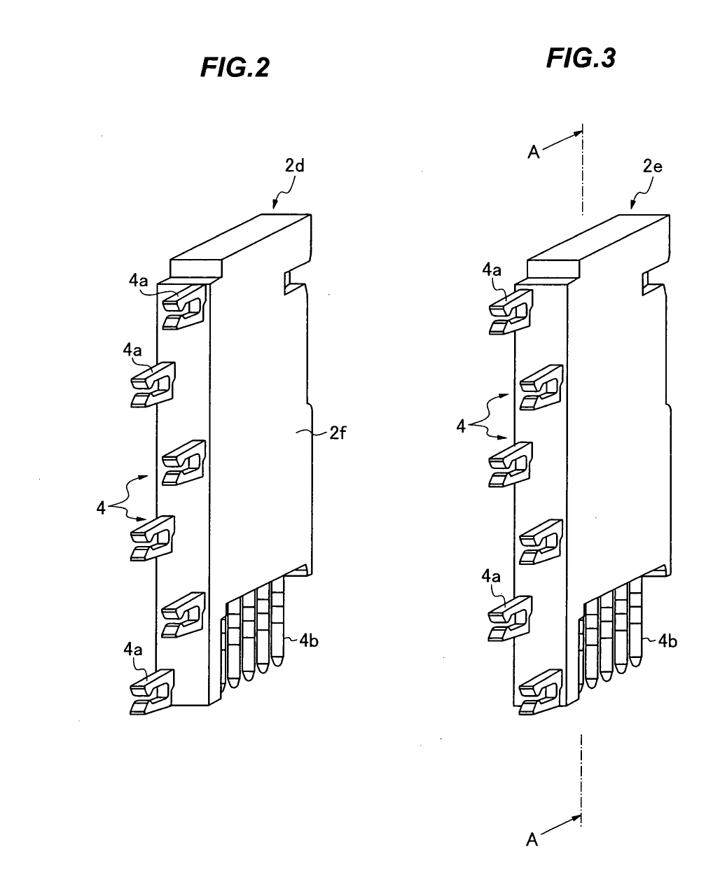

Thus, in the electric connector 1, as shown in FIG. 2, the housing 2a for female-type contacts comprises several module housings 2d formed by dividing the housing 2a along the vertical direction in alignment with the midpoint of the interval (a) of the terminal pair, and one of the female-type contacts 4 of the terminal pair is buried and integrally molded in the module housing 2d by the insert molding.

When the one of the contacts 4 of the terminal pair is set in a mold, as shown in FIG. 1, halfway points A, B of the relevant contact 4 are supported and fixed from both sides for molding. Accordingly, setting operation into the mold is facilitated.

In this way, the female-type contacts 4 at one side of respective terminal pairs are arranged in six stages in the vertical direction in the zigzag layout. A minimum distance between the female-type contacts 4 and an alignment surface 2f that is a sidewall of the module housing 2d is equal to half the interval (a).

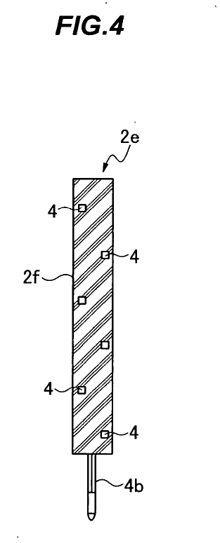

A module housing 2e shown in FIG. 3 to FIG. 4 is formed in a way that the female-type contacts 4 are disposed symmetrically with respect to the module housing 2d as shown in FIG. 2 so that they are formed as the other female-type contacts 4 of the terminal pairs.

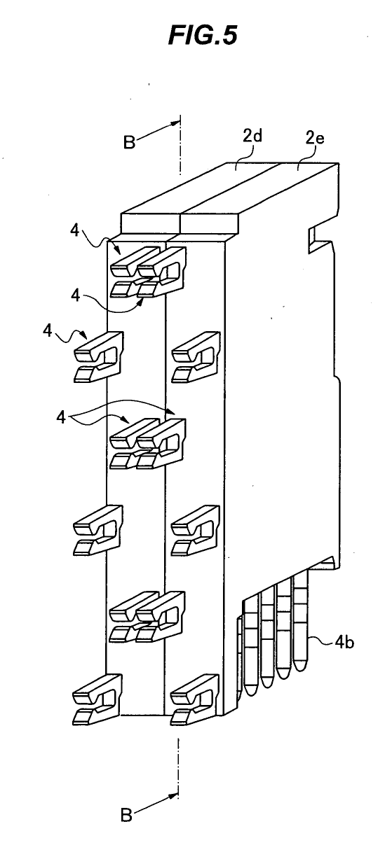

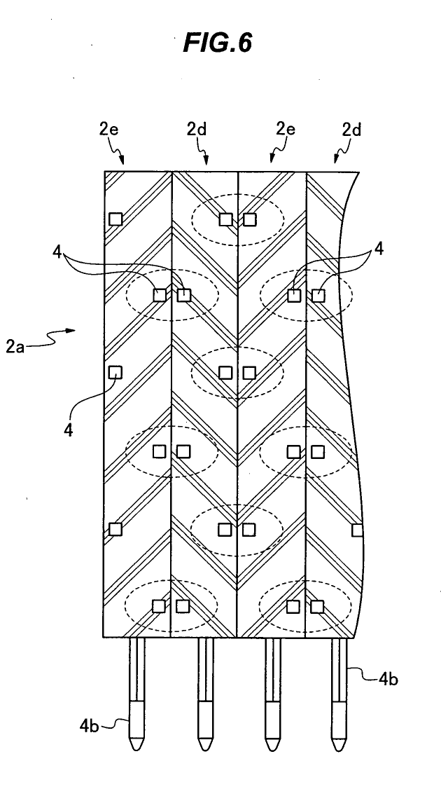

Once the module housings 2d, 2e are contacted at the alignment surface 2f to be adjacent to each other, as shown in FIG. 5 to FIG. 6, the female-type contacts 4, 4 of the terminal pairs appear in six stages in the vertical direction (with the same vertical interval (a) in the conventional example) and in the zigzag layout.

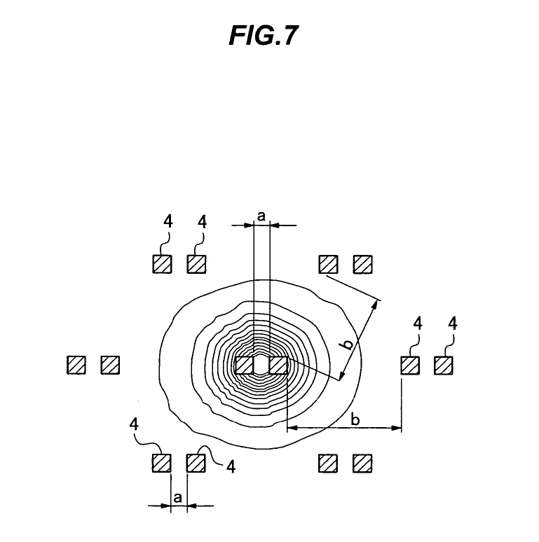

Furthermore, as shown in FIG. 7, the contacts 4 are set in the zigzag layout such that a ratio of the interval (a) (about 0.4 mm to 0.5 mm) between the two signal terminals of the female-type contact 4, 4 of the terminal pair to the interval (b) between the relevant terminal pairs is a/b≦⅓, so that the crosstalk is reduced in a high-speed transmission channel. The interval (b) between the relevant terminal pairs is easily set large by the zigzag layout of the terminals 4, 4 of the pairs.

In this way, each one of terminals of every one pair for transmitting an electric signal is integrated to several module housings 2d, 2e configuring the housing 2a for female-type contacts by insert molding. Since the integrally molded module housings 2d, 2e are aligned at the alignment surface 2f, the interval (a) between the female-type contacts 4, 4 of the terminal pair is not unevenly decreased or increased, consequently transmission characteristics are excellently maintained.

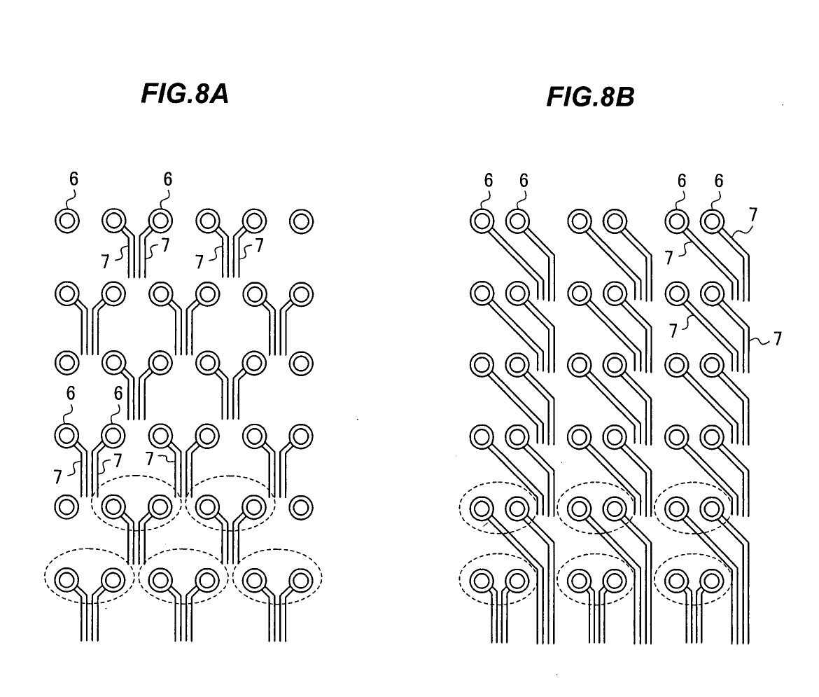

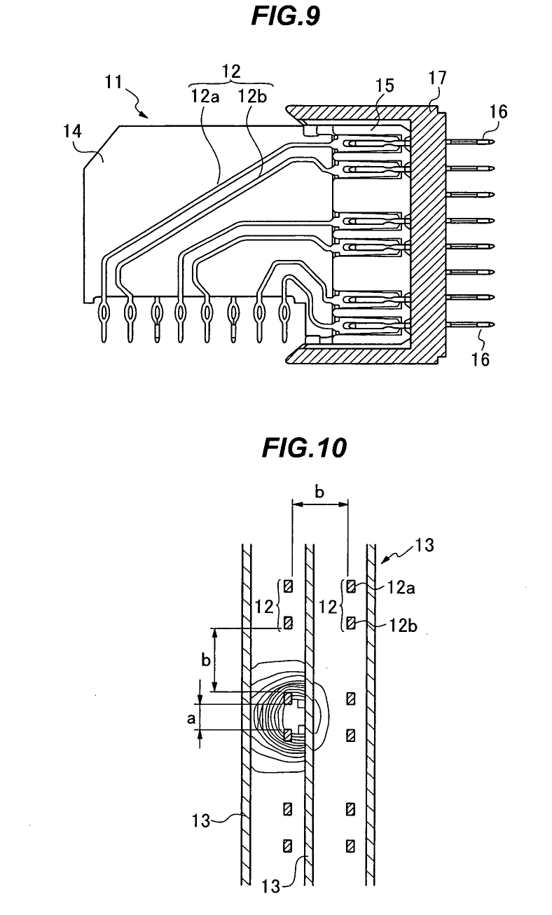

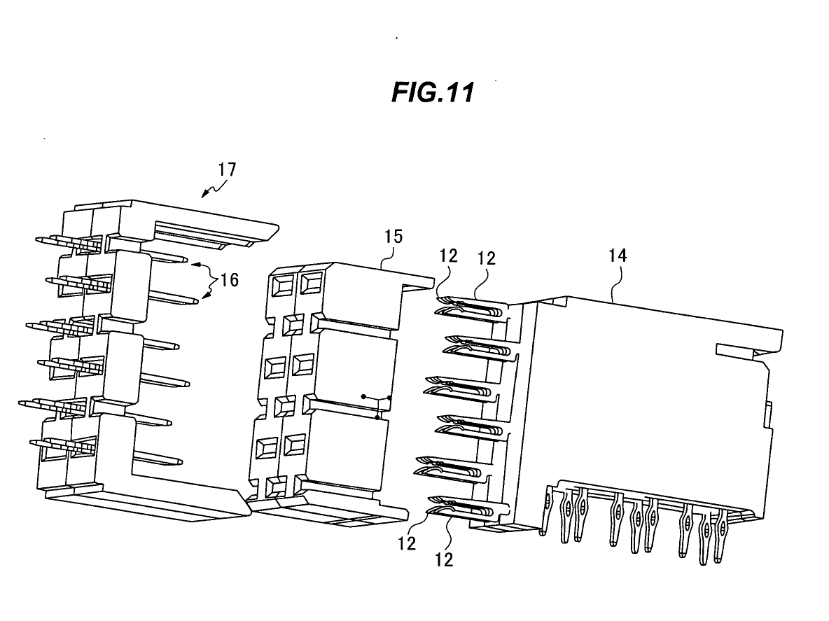

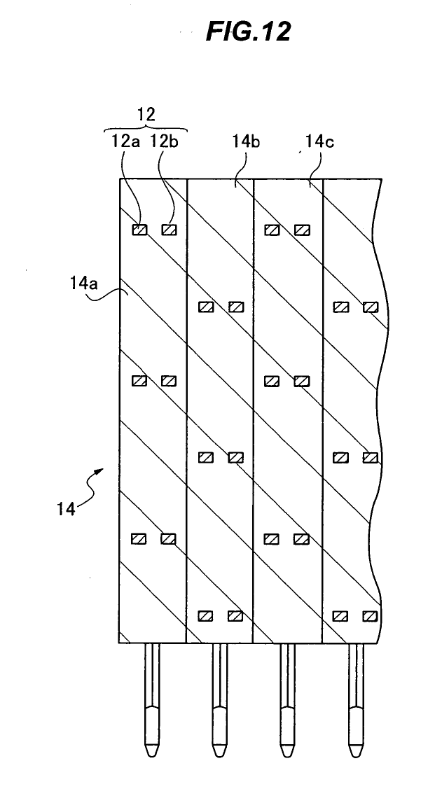

As shown in FIG. 8A, again in through-holes 6 in the printed circuit board into which the terminal parts 4b at the side facing the printed circuit board of the female-type contact 4 is pressed in, a method of leading out wiring patterns 7 is practiced in a way that the wiring patterns 7 are led out in a zigzag layout from the through-holes 6 in an approximately lattice layout, thereby wiring patterns are overlapped triply, consequently the wiring patterns can be formed using a three-layer board. For comparison, the wiring patterns are led out in a manner as shown in FIG. 8B; a five-layer board is needed, leading to increase in cost.

Next, the backboard connector 3 is described. The backboard connector 3 comprises a housing 3a for male-type contacts, and male-type contacts 5 which are pressed-in into contact insertion holes 3b arranged in the housing 3a and supported thereby. The contact insertion holes 3b are arrayed in correspondence with the array of the reception holes 2c of the package connector 2.

As above, in the electric connector 1 according to the invention, since one of the terminals of every one pair for transmitting an electric signal are integrally molded by insert molding in the housing 2a for female-type contacts, the interval (a) between the terminals of the pair is secured and securely held parallel. Accordingly, the reception holes 2c are arrayed in the zigzag layout to increase the interval (b) between the terminal pairs, in addition, the interval (a) between the terminals of the pair can be decreased, and therefore high-speed transmission characteristics can be improved.

### INDUSTRIAL APPLICABILITY

As above, the electric connector according to the invention improves crosstalk at a transmission channel for a high-frequency electric signal, wherein a terminal pair for transmitting an electric signal is configured by combining adjacent module housings, consequently an interval between signal terminals of the terminal pair can be set extremely small.

Moreover, an interval between terminal pairs can be easily held parallel. In that case, separate articles such as a spacer are not needed, therefore the number of components is not increased.

Furthermore, when a contact at one side of the terminal pair is set in a mold, since halfway points of the relevant contact can be supported and fixed from both sides for molding, setting operation into the mold is facilitated, and transformation and bend of the contact can be prevented; which is useful.

Moreover, the reception holes are arrayed in the zigzag layout, thereby the interval (b) between the terminal pairs received therein is increased, and consequently crosstalk can be much reduced.

1. An electric connector, having a plurality of signal terminals, a housing for female-type contacts in which the signal terminals are buried and integrally molded in a synthetic-resin housing with one ends of them being exposed, and a joint housing formed in a way that reception holes for receiving every one terminal pair, in which terminals are set close to each other in a horizontal direction in order to transmit an electric signal through the signal terminals, are lined up in the horizontal direction and set in several stages in a vertical direction, in which a relation of an interval (a) between the two signal terminals of the terminal pair to an interval (b) between the terminal pairs is a<b; characterized in that,
the two signal terminals of the terminal pair are separately buried and integrally molded in a module housing, which is formed by dividing the housing for female-type contacts along the vertical direction in alignment with the midpoint of the interval (a) in the terminal pair.

2. The electric connector according to claim 1, wherein the reception holes are arranged in a zigzag layout in vertical, two stages.
